(19) United States
(12) Patent Application Publication
(10) Pub. No.: US 2004/0252879 A1
(43) Pub. Date: Dec. 16, 2004

(54) Method and system for analyzing and tracking defects among a plurality of substrates such as silicon wafers

(75) Inventors: Timothy R. Tiemeyer, Randolph, MA (US); James S. Akutsu, Norwood, MA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: ADE Corporation

(21) Appl. No.: 10/864,963

(22) Filed: Jun. 10, 2004

Related U.S. Application Data
(60) Provisional application No. 60/477,407, filed on Jun. 10, 2003.

(51) Int. Cl. G06K 9/00; G01N 21/00

(52) U.S. Cl. 382/145; 356/237.4

(57) ABSTRACT

A population of data points each having three or more parameters associated therewith, such as multi-channel defect data from an optical scanner, are plotted in three dimensions, and groupings of data points are identified. Boundary surfaces are defined in the three-dimensional space for delineating groupings of data points. The different groupings correspond to different data classifications or types. Classification algorithms based on the boundary surfaces are defined. When applied to defect classification, the algorithms can be exported to an optical scanner for runtime classification of defects. An algorithm for identifying a particular grouping of data points can be defined as a Boolean combination of grouping rules from two or more different n-dimensional representations, where n can be either 2 or 3 for each representation.

### CROSS-REFERENCE TO RELATED APPLICATION

The present application claims the benefit of the filing date of U.S. Provisional Patent Application No. 60/477,407 filed Jun. 10, 2003, currently pending, the entire disclosure of which is incorporated herein by reference.

### FIELD OF THE INVENTION

The invention relates generally to methods and systems for analysis and classification of a population of data points, which can be applied to the detection and classification of defects occurring on or beneath the surface of a substrate such as a silicon wafer used in the production of integrated circuits.

### BACKGROUND OF THE INVENTION

Optical inspection techniques are increasingly being used for inspecting surfaces of articles such as silicon wafers, computer disks, glass plates, and the like, for detecting very small defects. In many applications, it is desirable to be able to detect particles on the surface, pits in the surface, voids beneath the surface, microscopic scratches, growths out of the surface, and other types of defects.

Optical inspection methods based on the scattering of light from a defect have been developed and have been used for several years as a means of detecting and mapping defects and contamination on surfaces. Most such methods have not been capable of discriminating between types of particles and other defects, but merely detect the presence of a defect and its size.

In some applications, however, it can be important to be able to distinguish the various types of possible defects from one another. For example, in the semiconductor industry, silicon wafers that are found to have particles on the surface after polishing can be subjected to further cleaning operations in order to eliminate the localized light-scattering events. However, if the defects are pits in the surface or voids beneath the surface, further cleaning will not be effective in this regard. If the wafer inspection system is not capable of discriminating between particle and non-particle types of defects, then inevitably time and resources will be futilely expended attempting to remedy some defective wafers having defects that cannot be removed. Furthermore, if the manufacturer is unable to classify defects as pits or voids, it is more difficult to take appropriate steps to reduce the incidence of pits and voids, which typically are caused during the bulk manufacturing of silicon from which wafers are made. It is also desirable to be able to distinguish between defects that are a nuisance but are not fatal to the usability of a wafer, and defects that are critical because their presence renders a wafer unusable or severely hinders the usability of the wafer.

Similarly, patterned wafers are typically inspected following a chemical-mechanical polish (CMP) operation in order to detect surface defects in the polished surface of the patterned wafer. In the course of the CMP operation, microscopic scratches (e.g., on the order of 0.25 μm wide by 0.25 μm deep by 5 μm long) are sometimes formed in the oxide film layer of the wafer. This can be caused, for example, by contamination of a polishing pad by foreign matter. It is important to be able to distinguish between such scratches and particles on the surface of the wafer. If the defect can be identified as a scratch, then adjustments can be made to the CMP process in order to prevent or reduce the scratching.

Thus, it is evident that significant advantages would flow from the ability to accurately and reliably classify various types of defects occurring on, in, or beneath the surface of the wafer. One approach to identifying and classifying defects entails impinging the wafer surface with a beam of collimated light so that any defect present at the surface causes the light to be scattered into the space above the surface. It has been noted that different materials and/or geometries of defects scatter light in consistently different ways, and thus the distribution of the scattered light in the space can be detected and used to classify defects based on the detected distribution. The detection generally involves positioning two or more discrete light collectors at different locations in the space above or below the substrate, with each collector being associated with a detector operable to generate a signal proportional to the intensity of the collected light. The signals from the various detectors, sometimes referred to as the “channels” of the optical inspection device, are subjected to computer analysis in order to determine what classification likely applies to a given defect.

In previous classification schemes, various techniques have been employed in order to determine one or more characteristics of the scatter pattern that tend to be shared by defects of the same type. For instance, as described in U.S. Pat. No. 6,509,965, it has been noted that when the incident light beam comprises P-polarized light, and the scattered light intensity is plotted as a function of scattering angle, the resulting intensity distribution, in general, has one characteristic shape for particles and a different characteristic shape for pits. This knowledge can be used to position light collectors in certain regions of the space so as to be able to distinguish pits from particles. The drawbacks of such prior schemes include the necessity of exporting channel data to third-party software and then generating classification algorithms based on manual analysis (e.g., using an atomic force microscope, scanning electron microscope, or optical microscope), or the necessity of using theoretical and/or empirical models of scattering behavior to predict channel relationships for various defect types. These approaches have not been entirely satisfactory. Manual analysis obviously is quite laborious and inefficient, and models are only as good as the assumptions that go into them.

Thus, prior to the present invention, there has been a need for a more-efficient and more-reliable method and system for classifying defects.

### SUMMARY OF THE INVENTION

The invention in one aspect addresses the above needs and achieves other advantages by providing a method and system for analyzing and classifying a population of data points each having associated with it at least three independent parameters, wherein the population of data points is graphically represented in three dimensions by plotting three parameters associated with each point in a selected coordinate system. Thus, coordinates of each data point in the coordinate system are functions of the magnitudes of the three parameters for that point; the magnitude of each parameter can be positive, negative, or zero for each data point. At least one distinct grouping of data points in the three-dimensional representation is identified, and one or more boundary surfaces are defined in the three-dimensional representation to separate each distinct grouping from the rest of the population of data points. As a simple illustrative example, if a substantial number of data points are clustered in a volume having a roughly cylindrical shape, then a cylindrical boundary surface can be identified to encapsulate the cluster of points. The three parameters that are plotted are chosen in such a manner that data points that tend to cluster together in a particular region of the three-dimensional space tend to share some pertinent characteristic in common. In this manner, the one or more boundary surfaces delineate one or more regions of the three-dimensional space in which one or more pertinent characteristics tend to exist.

The method and system can be used in connection with the detection and classification of defect types on silicon wafers. In this regard, another aspect of the invention relates to the creation of wafer “maps”, i.e., graphical representations of scanned wafers having symbols displayed on the maps in locations corresponding to the locations of the defects they represent. The symbols may also have characteristics denoting attributes of the defects; for example, one symbol color, size, or shape may denote one defect type, another symbol color, size, or shape may denote another defect type, etc. The maps can be displayed side-by-side; alternatively, the maps can be overlaid to create a single composite map showing all defects for all wafers, or can be displayed in a “stacked” view with the maps spaced apart. The stacked view can be particularly advantageous in tracking defect types or root causes among a plurality of wafers. As an example, when a plurality of wafers are all manufactured from the same starting silicon boule, defects that may be suspected to have their origin in the boule can be tracked among the wafers. The stacked view can be displayed using suitable symbols for such a defect type so that the locations of the defects and the affected wafers can clearly be seen. In this regard, the wafers can be ordered in the same order they were cut from the starting boule, for instance. Alternatively, the wafers can be ordered in various other ways based on process parameters or other characteristics.

In another aspect of the invention, two or more different n-dimensional representations (where n can be 2 or 3) can be plotted for the same population of data, using one or more different parameters for one or more of the axes in the various n-dimensional representations. An algorithm for identifying a particular grouping of data points can be defined as a Boolean combination of grouping rules from two or more different n-dimensional representations.

The invention can be applied to classifying defect data from scanned wafers or other substrates, wherein graphical representations of defect data are used to define algorithms by which defects are classified. A method in accordance with one embodiment of the invention comprises steps of:

(a) generating a population of data points each comprising at least three independent parameters representing scan data obtained from scanning a substrate, wherein each data point corresponds to a particular location on the surface of the substrate;

(b) representing the population of data points in a three-dimensional representation wherein coordinates of each point in a coordinate system of said representation are functions of the magnitudes of three of the independent parameters;

(c) identifying one or more distinct groupings of data points in the three-dimensional representation; and

(d) defining one or more boundary surfaces in the three-dimensional representation that separate the one or more distinct groupings from the rest of the population of data points, whereby the one or more boundary surfaces delineate different defect types.

Preferably, the data points are graphically displayed in three dimensions. For instance, assuming a simple inspection device employing a single scan of a substrate and having three light detectors, each defect will generate three parameters, namely, the magnitudes of the signals from the three detectors. The three-dimensional graphical display can be created by plotting each data point in a three-dimensional coordinate system wherein one axis represents or is derived from the magnitude of a first detector signal, another axis represents or is derived from the magnitude of a second detector signal, and the third axis represents or is derived from the magnitude of a third detector signal. Various types of coordinate systems can be used, such as orthogonal, polar, etc. The coordinate axes can have various types of scales, including linear, logarithmic, etc. Furthermore, mathematical operations can be performed on one or more of the detector signals before plotting, and signals can be combined to derive a composite parameter for one or more of the coordinate axes.

In preferred embodiments of the invention, once the three-dimensional graphical display of the data is available, a human operator views the displayed data points and visually identifies one or more groups of points that tend to cluster together, and then creates one or more boundary surfaces to delineate each group from the general population of data points.

In other embodiments, at least a preliminary definition of the one or more boundary surfaces can be automated, for example, based on a statistical analysis of the data points. Refinement of the automatically defined boundary surface(s) can then be carried out using visual techniques to modify the boundary surface locations, orientations, and/or shapes so as to exclude/include data points in a particular group that the automatically generated boundary surfaces included/excluded.

A system for analyzing and classifying a population of data points each having at least three independent parameters associated therewith, in accordance with one embodiment of the invention, comprises:

a computer connected to a display device and operable to graphically display the population of data points in three-dimensional representation on the display device, wherein coordinates of each point in a coordinate system of said representation are functions of the magnitudes of three of the independent parameters, and wherein at least one distinct grouping of data points exists in the three-dimensional representation; and

computer means for defining one or more boundary surfaces in the three-dimensional representation that separate each distinct grouping from the rest of the population of data points.

In one embodiment, the computer means comprises a graphical user interface including a cursor and an input device operable to manipulate the cursor on the display device, the graphical user interface being operable to allow definition of one or more of the location, orientation, and shape of one or more of the boundary surfaces by manipulating the cursor. For example, the computer can be programmed with one or more predefined shapes (e.g., cylinders, planes, spheres, cones, cubes, etc.) and the graphical user interface can be operable to allow selection of one of the predefined shapes as a boundary surface by manipulating the cursor. For instance, the computer can be operable to display an icon on the display device for each of the predefined shapes and the graphical user interface can be operable to allow selection of one of the predefined shapes by placing the cursor on the icon corresponding to said predefined shape and dragging and dropping the icon onto the three-dimensional representation on the display device. Then, modification of the shape (e.g., enlarging, shrinking, rotating about one or more axes, translating along one or more axes, distorting, etc.) can be carried out, if necessary, by further manipulation of the cursor or by other means.

The computer preferably is programmed, along with the graphical user interface, to allow the operator to create a defect classification algorithm that takes into account at least one defined boundary surface. As a simple example, a defect may be classified as belonging to type “A” if its data point falls above (or below) a defined boundary plane, and as being other than type “A” if it does not fall above (or below) such plane. An algorithm can take into account more than one boundary surface. For instance, a defect may be classified as belonging to type “B” if its data point falls between two defined boundary surfaces, or within a defined boundary cylinder, and otherwise as not belonging to type “B”. Various other types of algorithms can be created. Furthermore, as already noted, an algorithm for identifying a particular grouping of data points can be defined as a Boolean combination of grouping rules from two or more different n-dimensional representations, where n can be 2 or 3 for each representation.

In a particularly preferred embodiment, the computer and display device are operable to simultaneously display a three-dimensional representation of the data points, the various two-dimensional projections of the three-dimensional representation (three in total) showing the data points, and a composite map showing all the data points; for example, these views may be side-by-side on the display; alternatively, they could be in separate windows. Preferably, the graphical user interface is operable to allow an operator to select a data point in any of the various views (e.g., by placing the cursor on the point and clicking a mouse button), and the same point is highlighted in the other views. The computer preferably is programmed to allow an operator to enter a defect type for the selected data point, thus “teaching” the system what defect type applies to each data point grouping.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 shows a screen shot from a display device on which there is displayed a three-dimensional representation of a population of defect data points, in accordance with one embodiment of the invention;

FIG. 2 shows a screen shot from a display device on which there is displayed the same three-dimensional representation as in FIG. 1, wherein a grouping of data points has been encapsulated within boundary surfaces for delineating the grouping from other data points, and wherein there is also displayed the two-dimensional projections of the data and boundary surfaces;

FIG. 3 shows a screen shot from a display device on which there is displayed the three-dimensional representation and the two-dimensional projections, with alternative planar boundary surfaces being defined in the various views, and also showing a composite wafer map on which all of the defect data points are located;

FIG. 4 shows a screen shot from a display device on which there is displayed the three-dimensional and two-dimensional projection views, the composite map, and a stacked-wafer view showing all of the wafers in a stack;

FIG. 5 shows a screen shot from a display device on which there is displayed a plurality of individual wafer maps in side-by-side arrangement, along with a textual classification summary of all defect data points; and

FIG. 6 is a diagrammatic depiction of a computer system for carrying out the method of the invention.

### DETAILED DESCRIPTION OF THE INVENTION

The present inventions now will be described more fully hereinafter with reference to the accompanying drawings, in which some but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

The exemplary embodiments of the invention described herein are based on an optical inspection device or scanner generally of the type disclosed in U.S. Pat. No. 6,509,965, incorporated herein by reference. The scanner is operable to direct a laser light beam at an oblique angle of incidence onto a wafer surface. The scanner includes three detectors for collecting and measuring the intensity of scattered light. The detectors comprise a “front” detector located in a forward region of the space above the wafer, a “center” detector located generally in the vicinity of a surface normal from a center of the wafer, and a “back” detector located in a back region of the space. It will be understood that “forward” and “back” are defined with respect to the location from which the incident light beam originates; thus, the front detector is positioned to detect light that is scattered generally in the direction in which the specularly reflected beam travels from the wafer surface, i.e., forward-scattered light. The back detector is positioned to detect light that is scattered generally in the opposite direction to the specularly reflected beam, i.e., back-scattered light. The scanner can also include a light channel detector for collecting specularly reflected light. It must be understood, however, that the invention is not limited to this or any other particular scanner configuration. Other detector configurations can be used, as long as a given defect ultimately provides at least three independent signals. The three (or more) signals can be provided in various ways: a single scan using three (or more) detectors; fewer than three detectors coupled with more than one scan (wherein the scans differ from each other in terms of incidence angle of the light beam, wavelength of the light, and/or polarization of the beam, for instance); etc.

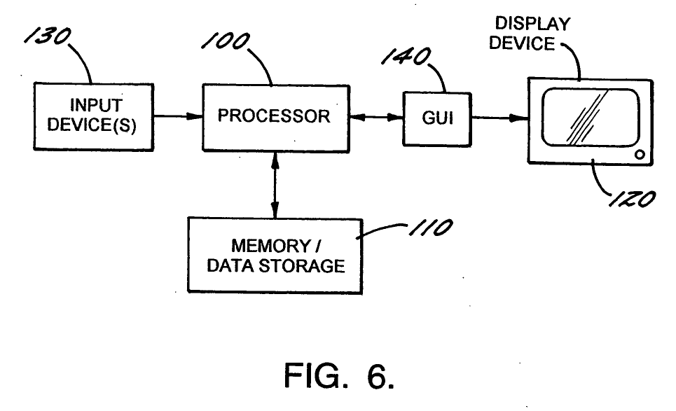

The scanning process generally entails scanning the incident beam across the wafer surface and periodically sampling the detector signals so as to create a collection of data points, each representing a discrete point on the wafer surface and each characterized by the magnitudes of the various detector signals. As noted, the scanning process must provide at least three different signal magnitudes for each point. For a given point on the surface, if no defect is present, the signal magnitudes will be zero or within the level of noise“that might normally be expected even from a defect-free region; however, if a defect is present, one or more of the signal magnitudes will be nonzero and substantially greater than the normal noise level. In accordance with the invention, all of the data points that have such nonzero signal levels are identified as at least potential defects for classification. The data (including all signals magnitudes, whether above or below the normal noise level) are imported from the inspection device to a computer system for defining classification algorithms based on the data, in accordance with the invention. As shown in FIG. 6, the computer system includes at least a CPU or processor 100, a data storage or memory device 110, a display device or monitor 120, and one or more input devices 130 (e.g., a keyboard, a mouse, etc.). The computer is equipped with a graphical user interface (GUI) 140, as further described below. For illustration purposes, the GUI is shown as separate from the processor 100, but it will be understood that the GUI can be implemented in hardware and/or software of the processor.

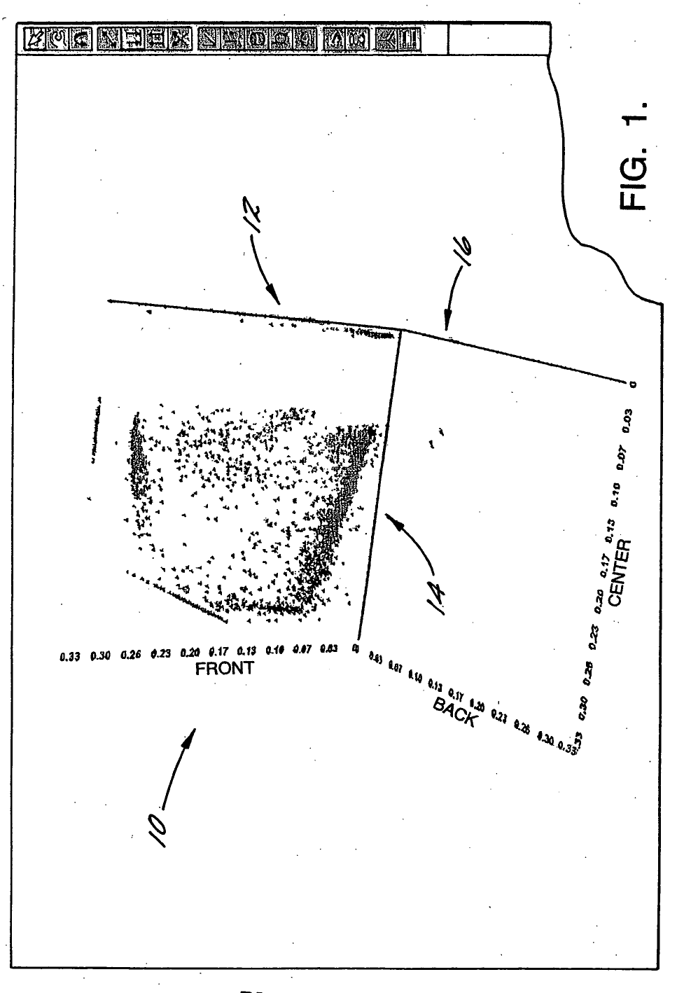

As shown in FIG. 1, one step of the method in accordance with the invention entails graphically displaying the defect data points in a three-dimensional representation 10 on the display device. The example screen shot of FIG. 1 assumes a light detector configuration having front, center, and back collectors as previously described. An orthogonal Cartesian coordinate system is defined wherein one axis 12 represents the front detector signal magnitude, another axis 14 represents the center detector signal magnitude, and the third axis 16 represents the back detector signal magnitude. Each data point is plotted in this three-dimensional coordinate system. A given axis alternatively can represent mathematical combinations or two or more detector signal magnitudes, or the signal magnitudes can be mathematically operated on in other ways before the data is plotted. The objective is to achieve good data separation, and any parameters and scales (e.g., linear, logarithmic, etc.) that help achieve that objective can be used.

The light detectors can detect either scattered (dark channel) or reflected/deflected (light channel) light, and dark channel and/or light channel data can be used in the three-dimensional plot. In addition to detector signal magnitudes, additional or different parameters can be plotted, including but not limited to date of a test, time of a test, lot number of the scanned wafer(s), wafer type, surface material properties such as thickness or flatness, or process characteristics such as temperature or speed.

Next, on the three-dimensional representation 10, clusters or groupings of data points are identified. For example, in FIG. 1 it can be observed that a substantial number of data points are clustered into a fairly well-defined region of the space characterized by relatively large center detector signal magnitude (having values from about 0.10 to about 0.30), and at least a substantial portion of the region has a generally cylindrical configuration extending generally left to right in FIG. 1. There is also a clustering of data points that extends generally upward from the left-hand end of the first clustering. Through independent verification techniques applied to a representative sampling of the data points in these clusters, it can be determined that substantially all of the data points in these two clusters belong to a common defect classification (which will be referred to generically as Type A), and thus these points should be considered as a single grouping for classification purposes.

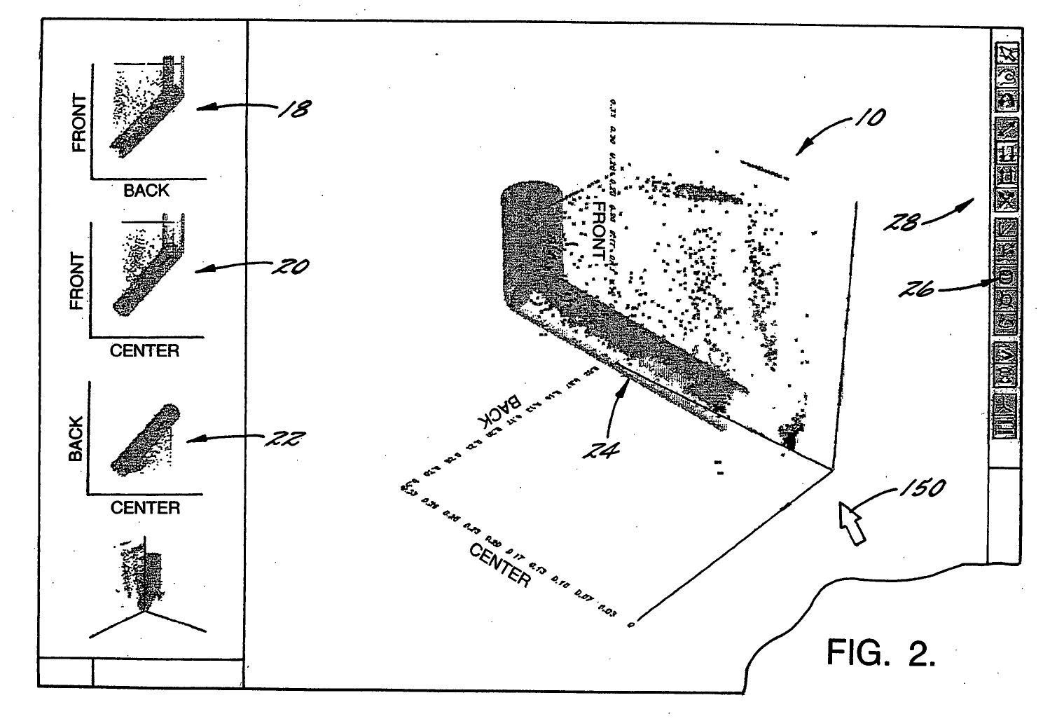

The next step is to create boundary surfaces to delineate this grouping from other regions of the space, so that any data point falling within the region defined by the boundary surfaces can be classified as belonging to the Type A classification. Various types of boundary surfaces can be defined in accordance with the invention. FIG. 2 illustrates one type of boundary surface that can be defined. On the display device, the three-dimensional representation 10 is displayed; preferably the two-dimensional projections 18, 20, and 22 of the representation along the directions of each of the three coordinate axes are also displayed. The operator defines a cylindrical boundary surface 24 in the three-dimensional space, encapsulating the grouping of data points that belong to the Type A classification. The boundary surface is actually made up of two different cylindrical surfaces joined together. Preferably, the graphical user interface 140 of the computer includes features facilitating the definition of such boundary surfaces. For instance, with reference to FIG. 2, the GUI can display icons representing various predefined shapes programmed in the computer, such as a line 26a, a plane 26b, a cylinder 26c, a sphere 26d, etc. Preferably, the GUI allows the operator to select one of these shapes and locate and orient it on the three-dimensional representation 10. For instance, the GUI can cause a cursor 150 (FIG. 2) to be displayed on the display screen, which can be manipulated by the operator using an input device (e.g., a mouse). The GUI can allow the operator to position the cursor on a selected one of the icons 26a-c and select it (e.g., by clicking a mouse button). In a preferred embodiment, the GUI allows the operator to “drag and drop” the boundary shape represented by an icon onto the three-dimensional representation 10 using the cursor. The one or more boundary surfaces preferably are simultaneously displayed in all of the views 10, 18, 20, 22 on the display device to assist the operator in tailoring the surface(s) to fit the data points.

The GUI preferably also creates other icons 28 that correspond to particular operations that can be performed on the one or more boundary surfaces that have been inserted into the 3D plot 10, or other operations that can be performed. For example, an icon 28a when selected allows the operator to work with the 3D plot to manipulate the plot view (e.g., rotate, zoom in or out, etc.). Icon 28b allows the operator to work with a boundary surface as opposed to the plot. Icon 28c performs an “undo” to reverse a previous operation. Icon 28d “grabs” an end of a boundary surface to allow it to be moved while the opposite end remains fixed. Icon 28e when selected results in data points below (or inside) a selected boundary surface being included in a classification. Icon 28f when selected results in data points above (or outside) a selected boundary surface being included in a classification. Icon 28g deletes a selected boundary surface.

The GUI can also include additional icons and operations. For instance, icon 29a allows the 3D plot to be rotated for viewing the plot from different perspectives. Icon 29b effects the construction of a classification algorithm based on the boundary surface(s) that have been created and the inclusion/exclusion rules applied to them as already described. For instance, in a simple example wherein two boundary planes have been created parallel to each other and data points between the planes are to be included in the classification, icon 28e is applied to one of the planes and icon 28f is applied to the other plane. Selection of icon 29b than creates an algorithm by “anding” the two rules for the two planes; i.e., a defect is included in the classification if it is below one of the planes and is above the other of the planes. Algorithms can also include “or” Boolean operators, or can include both “and” and “or” operators. Icon 29c selects an “overlay” function that allows two or more separate populations of data points to be plotted on the same plot, which can be useful, for example, for viewing both “pre-wash” and “post-wash” scan data as further described below. Icon 29d when selected resets the display to a predetermined default view. Finally, icon 29e calls up a menu of drawing options that can be selected to govern the appearance of various aspects of the 3D plot and boundary surfaces, such as symbol colors, wire frame view of boundary surfaces, translucent view of boundary surfaces, etc.

The computer is programmed to update its mathematical definition of the boundary surface(s) to reflect the modifications made to the boundary surface(s) by the operator. Thus, ultimately the operator arrives at one or more boundary surfaces that delineate all or substantially all of the data points in the grouping or classification that has been identified. The one or more boundary surfaces are stored by the computer in the form of a mathematical definition of any suitable type.

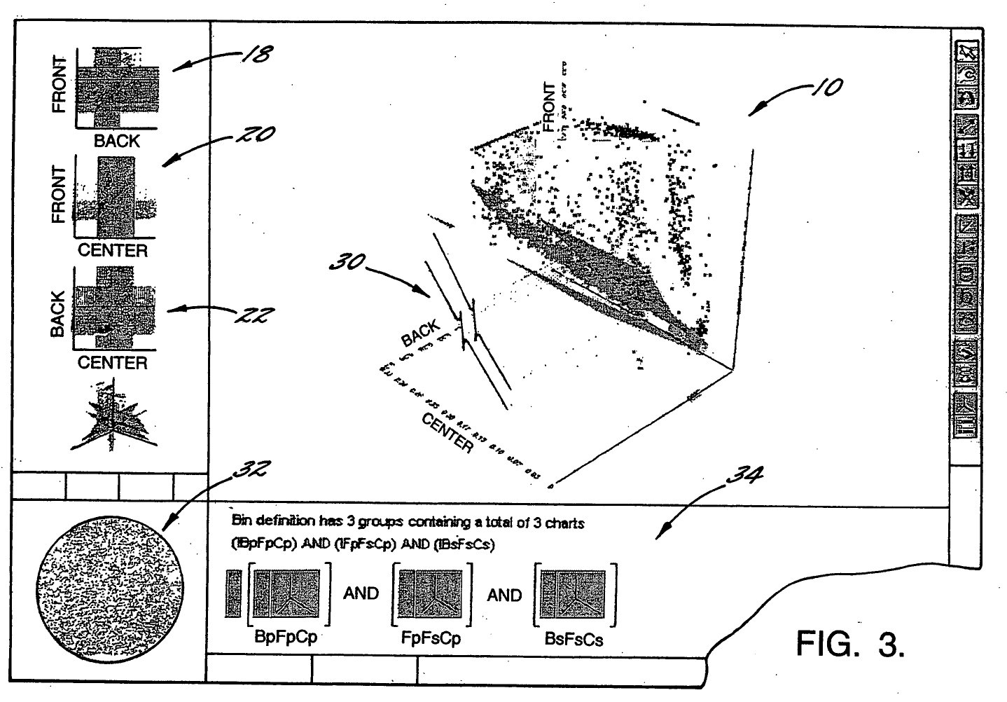

FIG. 3 illustrates another possible boundary surface definition, wherein a plurality of planar boundary surfaces 30 are defined for delineating data point groupings. Again, the planes preferably can be dragged and dropped, and then modified as necessary to fit the data. FIG. 3 also illustrates that preferably the computer is operable, in another display mode, to display a wafer composite map 32. The composite map is a graphical representation of a plurality of scanned wafers, overlaid one upon another, with each defect on each wafer being represented by a symbol in the correct location with respect to the wafer. The symbols can be of different colors and/or different shapes that correspond to different defect classifications or other characteristics of the defects or the scans that detected them. Advantageously, the computer and GUI are also operable to allow an operator to select (such as by pointing and clicking with a mouse cursor) any data point(s) on one view such as the composite map, and the data point(s) is (are) highlighted in that view as well as the other views such as the 3D plot 10 and the 2D projection views 18, 20, 22.

As shown in FIG. 3, the computer preferably is also operable to display in a display window 34 the classification algorithm, also referred to as a “bin definition”, corresponding to the boundary surfaces that have been defined on the 3D plot 10. As noted, in accordance with the invention, an algorithm for a particular classification of data is not restricted to the use of a single plot, but can be based on two or more plots. The two or more plots can be n-dimensional, where n is either 2 or 3. The two or more plots do not all have to have the same n value; thus, for example, one or more 3D plots can be used along with one or more 2D plots; alternatively, all of the plots can have the same n value (either 2 or 3). For instance, in the example shown in FIG. 3 in display window 34, a classification algorithm has been created as a Boolean combination (with “and” operators in this particular example) of classification rules from three different 3D plots that have different parameters for their axes. For each plot, one or more boundary surfaces are defined as previously described so as to delineate a particular data grouping. The “rules” thus formed by the boundary surface(s) for each plot are then combined with suitable Boolean operators to arrive at an appropriate classification algorithm.

If one or more of the plots used in the classification is a 2D plot, then of course boundary curve(s) or line(s) are employed rather than surfaces for delineating a data point grouping.

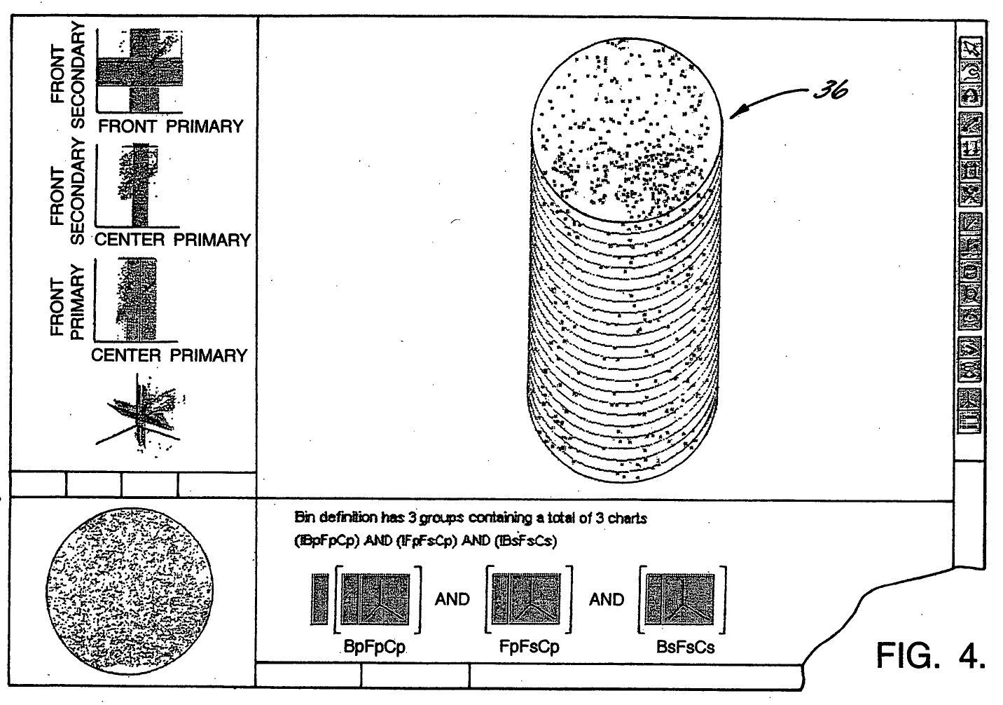

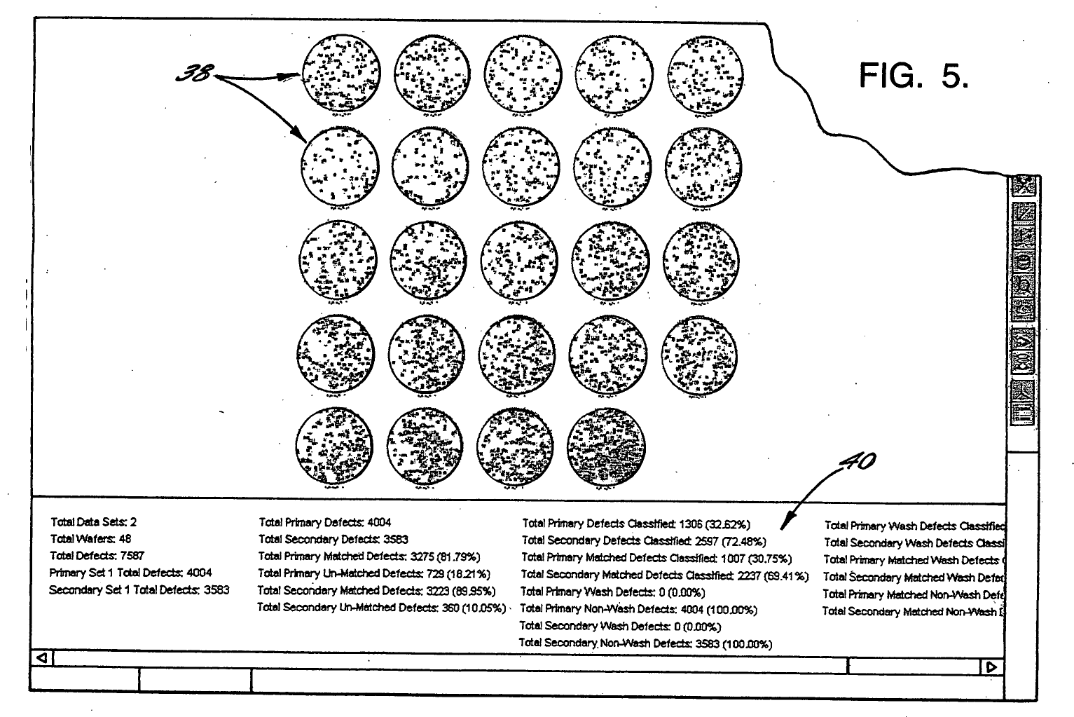

In another display mode shown in FIG. 4, the computer preferably is operable to display a “stacked wafer” view 36 in which all scanned wafer maps are shown stacked one upon another and slightly spaced apart, with the defects indicated by symbols. Another way of viewing the wafer maps in another display mode is shown in FIG. 5, wherein all of the individual wafer maps 38 are shown in a side-by-side arrangement. This display mode can also include a window 40 that lists a textual summary or statistics of all defects or selected defects.

The computer and GUI preferably are programmed so that a user can select a particular defect data point (e.g., by pointing and clicking on the point) in any of the views 10, 18, 20, 22, 32, 36, 38 and then enter a defect type for that defect data point. In this manner, the system is “taught” which defect type applies to that point, and the entered defect type is stored in memory along with the other information associated with the selected data point. The system can thus be taught the defect types for points in each of several different regions of the three-dimensional space. Accordingly, when data points from subsequently scanned wafers fall into the various regions as defined by the classification algorithms or bin definitions, the defect type that most likely applies to each point can be determined.

Once appropriate classification algorithms based on the boundary surfaces in one or more of the plots are defined for a set of wafer scan data, the algorithms can be “exported” from the computer of the system to a computer associated with an inspection device. Defects detected on sets of wafers that are scanned in the inspection device are analyzed by the device's computer to determine where the data points fall with respect to the boundary surfaces, i.e., to determine what “bin” or classification each data points falls into based on the classification algorithms. The inspection device's computer can keep statistics on the defects, as shown in window 40 in FIG. 5. The statistics can, for example, keep track of how many total defects are present, what percentage of the defects were successfully classified using the defined algorithms, etc. The computer can also break down the defects into “pre-wash” and “post-wash” defects, i.e., which defects were present before the wafers were subjected to a washing operation, and which were present after the washing operation (i.e., the wafers would be scanned both before and after wash). Additionally, the computer can keep track of where the defects were located before wash, and where they were located after wash, and the computer can determine which post-wash defects correspond to the same locations as pre-wash defects; these defects are referred to as “matched” defects, the assumption being that a post-wash defect that has the same location as a pre-wash defect is in fact the very same defect that was unaffected by the wash operation. By contrast, “un-matched” defects are those post-wash defects for which there are no pre-wash defects having the same locations, or those pre-wash defects for which there are no post-wash defects having the same locations.

The invention can also be applied to multi-scan systems wherein a wafer is scanned using a first scanner configuration (e.g., P-polarized light at a first incidence angle), and is also scanned (sequentially or simultaneously in relation to the first scan) using at least a second scanner configuration (e.g., S-polarized light at the first incidence angle, 45-degree polarized light at the first incidence angle, P-polarized light at a second incidence angle, etc.). The first (primary) scan generates one set of defect data, and the second (secondary) scan generates another set of defect data. Just as matching can be done between pre-wash and post-wash defects, a similar matching can be done between primary and secondary defect data points.

The foregoing description has assumed that the identification of data point groupings is performed visually by an operator. However, the invention is not limited to such visual techniques. At least a preliminary identification of data point groupings and definition of boundary surfaces can be performed by the computer using a statistical analysis of the data, for example. The automatically generated boundary surfaces can then be modified by an operator in a manner similar to what has already been described.

Alternatively, a density recognition process can be applied to the data to identify regions of high data point density or clustering, and the computer can generate preliminary boundary surfaces based on the identified clusters.

As noted, the computer can be operable to display a “stacked” wafer view 36 (FIG. 4) in which all scanned wafer maps are shown stacked one upon another and slightly spaced apart, with the defects indicated by symbols. The stacked view can be advantageous in revealing patterns or trends in certain defects types among a plurality of wafers. As one example, consider an instance in which a plurality of silicon wafers are all cut from the same ingot or boule of silicon, and the various wafers are tracked during subsequent scanning and processing so that it is known for each wafer where in the boule that wafer was cut from. The stacked wafer view can be displayed such that the wafers are in the same order in which they were cut from the boule. One or more defect types attributable to defects in the original boule can then be represented on the various wafer maps by a symbol that is distinguishable (e.g., in color, shape, and/or size) from other defects types. This can provide a visual depiction of how the defect type is propagated through the boule.

Alternatively, the symbols representing the wafer defects can be colored, shaped, and/or sized to highlight particular process characteristics such as temperature variations, or rate at which the silicon boule was formed or “pulled”. In this latter regard, based on the pull rate, it is possible to track the relative time during the boule formation that corresponds to each wafer, and this relative time can be associated with each of the data points for the wafer. In this manner, it is possible, for example, to display selected ones of the wafer maps based on the relative time of formation of the wafers, and/or to order the displayed maps based on the relative time of formation.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method for analyzing scan data from a plurality of silicon wafers, wherein for each wafer the scan data comprises a population of data points each corresponding to a particular location on the wafer and each having associated therewith a plurality of independent parameters indicative of the presence or absence of a defect at said location on the wafer, and wherein the populations of data points indicate a plurality of different defect types, the method comprising the steps of:
graphically representing each wafer as a wafer map;
on each wafer map, plotting symbols representing those data points from the corresponding population of data points that indicate at least one defect type, the plotted symbols being plotted on the wafer map at the locations associated with the data points such that each wafer map provides a graphical depiction of the at least one defect type present on the wafer corresponding to the wafer map; and
arranging the wafer maps in a predetermined order based on at least one known characteristic of the wafers and/or process by which the scan data was obtained.

2. The method of claim 1, wherein two or more defect types are plotted on the wafer maps, and the symbols for each defect type are visually distinct so that the defect types can be distinguished from each other.

3. The method of claim 1, wherein the wafers all originate from the same starting silicon boule, and the wafer maps are arranged according to relative positions of the wafers in the boule.

4. The method of claim 3, wherein the at least one defect type plotted on the wafer maps includes a defect type attributable to the starting boule of silicon.

5. The method of claim 3, wherein a relative formation time of each wafer during formation of the boule is tracked for each wafer, and wherein wafer maps are selected and/or ordered based on the relative formation times of the wafers.

6. The method of claim 1, wherein the symbols are chosen to indicate one or more characteristics of the scan process that generated the scan data.

7. The method of claim 1, wherein the wafer maps are displayed in a stacked view with the wafer maps arranged in a stack and spaced apart.
